(19) United States
(12) Patent Application Publication
(10) Pub. No.: US 2008/0223457 A1
(43) Pub. Date: Sep. 18, 2008

(54) Bi-directional valve

(76) Inventors: Danko A. Kobziar, Williamsville, NY (US); Steven M. SanFilippo, Lancaster, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/069,031

(22) Filed: Feb. 7, 2008

Related U.S. Application Data
(60) Provisional application No. 60/900,029, filed on Feb. 7, 2007.

(51) Int. Cl. F16K 17/26

(52) U.S. Cl. 137/493

(57) ABSTRACT

A bi-directional valve having a housing with at least one internal gasket contact surface. A spring holds the plate, flapper and gasket against the internal gasket contact surface of the housing. When a predetermined pressure acts on the plate and flapper, the plate, flapper and gasket move away from the gasket contact surface to allow flow through the bi-directional valve in a first direction. To flow in the opposite direction the plate and gasket abut against the housing and the flapper opens to allow flow in an opposite direction. The same flow path is used for flow in either direction through the bi-directional valve.

### CROSS-REFERENCE TO RELATED APPLICATION

This application claims benefit of U.S. Provisional Patent Application Ser. No. 60/900,029 filed on Feb. 7, 2007, which is incorporated herein by reference.

### BACKGROUND

In respiratory masks and similar devices, provisions must be made for fluid to enter the device and fluid to exit the device. In aviation masks, this fluid transfer must take place in a device that minimizes both weight and physical volume while maintaining efficient performance. One valve that combines the function of what are now two separate valves will help to accomplish this task.

Thus, what is needed is a better apparatus which is smaller and lighter and provides the user with sufficient oxygen to satisfy the user's breathing requirements.

### SUMMARY

A bi-directional valve is provided which is part of the breathing mask or aviation mask. In a first embodiment the bi-directional valve includes a housing, a plate, a gasket and a diaphragm member having a flapper. The gasket is joined to one side of the plate and the diaphragm is supported by the plate. The flapper seats against the gasket. A spring abuts against the other side of the plate such that the gasket is held against the housing when the bi-directional valve is in a closed position. The bi-directional valve opens when a sufficient pressure acts on the plate causing the spring to compress. Gas flows around the plate and out the bi-directional valve. The bi-directional valve also provides for flow in the opposite direction through the same flow path if the pressure differential is reversed. In this situation the gasket is held against the housing by the spring, and gas flows through the flapper in the opposite direction.

In another embodiment, the bi-directional valve has first and second housing halves, a spring and first and second plates each having a gasket. Each of the first and second plates supports a diaphragm having a flapper. The spring is positioned between the first and second plates such that that one of the gaskets presses against the first housing half and the other gasket presses against the second housing half. The first plate opens at a specific pressure determined by the spring and the area of the plate to allow flow in a first direction and the second plate opens at a specific pressure to flow in the opposite direction. The flappers open and close in the same manner as described in connection with the embodiment described above.

### BRIEF DESCRIPTION OF DRAWING FIGURES

A bi-directional valve is illustrated throughout the drawing figures. The same reference number is used to call out the same or similar surfaces, structures or features throughout the drawing figures of the embodiments of the bi-directional valve, wherein:

FIG. 1 is a sectional view of a bi-directional valve in a steady state with no flow through the valve.

FIG. 2 is a sectional view of the bi-directional valve as it appears when a high pressure is applied to the plate and the bi-directional valve opens.

FIG. 3 is a sectional view of the bi-directional valve wherein the flapper is an open position to allow free flow through the bi-directional valve in a direction opposite the direction of flow shown in FIG. 2.

FIG. 4 is a plan view of the flapper plate.

FIG. 5 is a plan view of an alternate embodiment of the flapper plate.

FIG. 6 is a sectional view of a second embodiment of a bi-directional valve in a non-operational or steady state.

FIG. 7 is a sectional view of the second embodiment showing flow through the low pressure side of the bi-directional valve.

FIG. 8 is a sectional view of the second embodiment showing flow through the high pressure side of the bi-directional valve in a direction opposite to FIG. 7.

FIG. 9 is a plan view of a gasket.

FIG. 10 is a cross-sectional view taken along lines 10-10 of FIG. 9.

FIG. 11 is a plan view of the flapper plate.

FIG. 12 is a cross-sectional view taken along lines 12-12 of FIG. 11.

FIG. 13 is a cross-sectional view taken along lines 13-13 of FIG. 11.

FIG. 14 is a plan view of the spring retainer.

FIG. 15 is a cross-sectional view taken along lines 15-15 of FIG. 14.

FIG. 16a is a top plan view of a housing.

FIG. 16b is a side elevational view of the housing shown in FIG. 16a.

FIG. 17 is a cross-sectional view taken along lines 17-17 of FIG. 16a.

FIG. 18a is a top plan view of a housing.

FIG. 18b is a side elevational view of the housing shown in FIG. 18a.

FIG. 19 is a cross-sectional view taken along lines 19-19 of FIG. 18a.

FIG. 20 is a side view of an alternate embodiment of the valve of FIG. 1.

FIG. 21 is a side view of another alternate embodiment of the valve of FIG. 1.

FIG. 22 is a side view of another alternate embodiment of the valve of FIG. 1.

FIG. 23 is a side view of a mask with a bi-directional valve, shown in the initial stage of inhalation.

FIG. 24 is a side view of a mask with a bi-directional valve, shown in a subsequent stage of inhalation.

FIG. 25 is a side view of a mask with a bi-directional valve, shown during exhalation.

### DESCRIPTION

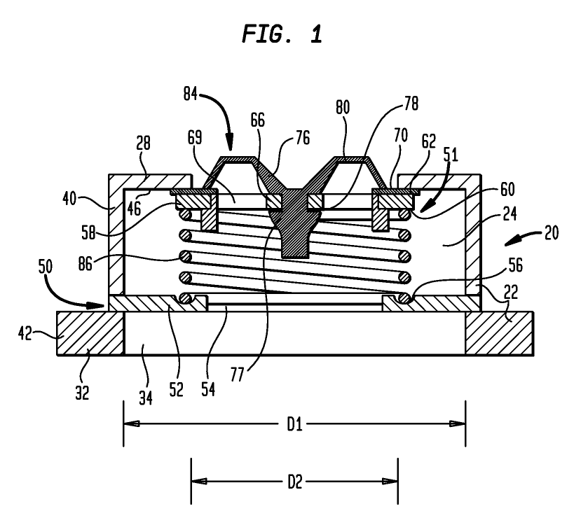

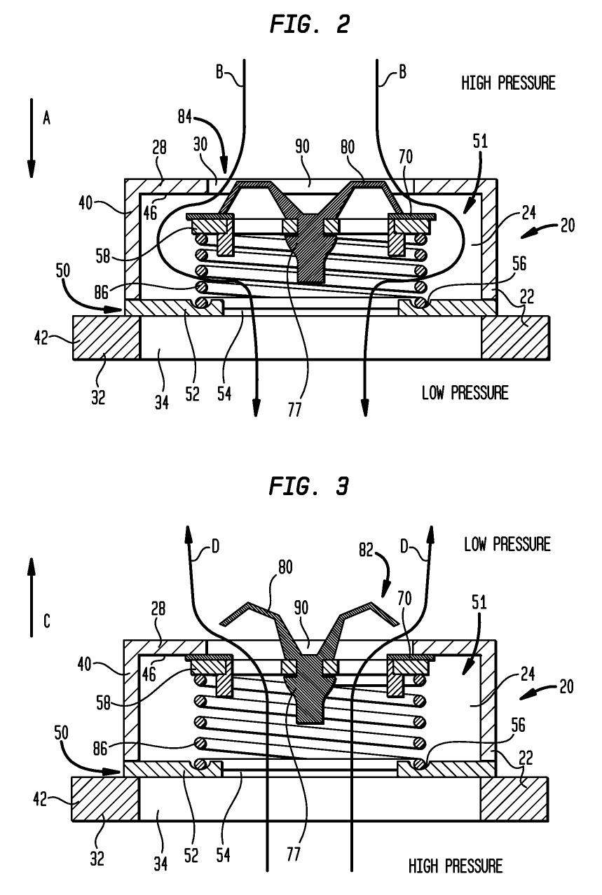

FIGS. 1-3 show a bi-directional valve 20. The bi-directional valve 20 includes a housing 22 having an interior 24. The housing 22 has a first side 28 with a first opening 30, best shown in FIG. 2, and an opposed second side 32 with a second opening 34. As shown in FIG. 1, the second opening 34 has a diameter designated D1 that is greater than the diameter designated D2 of the first opening 30.

The housing 22 has a first housing portion 40 that extends to a second housing portion 42. The first housing portion 40 and the second housing portion 42 are one piece, or can be embodied to be two pieces that are connected to one another. The first housing portion 40 has an internal gasket contact surface 46 and a recess 50 proximal the second housing portion 42.

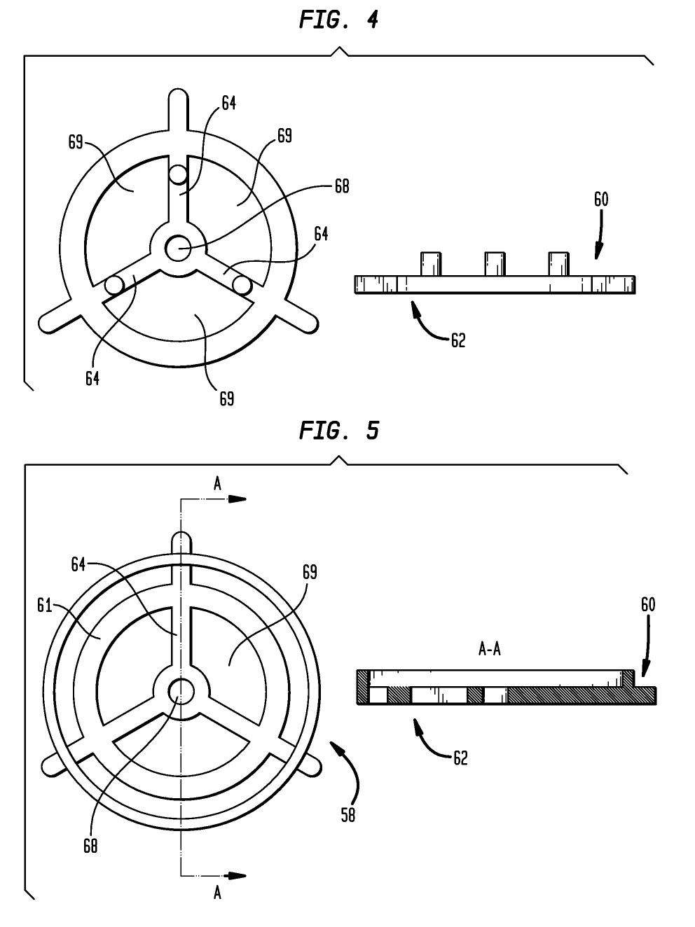

As shown in FIG. 1, positioned in the interior 24 of the housing 22 is a valve assembly 51 that includes a first spring retainer 52 which is positioned in the recess 50. The first spring retainer 52 has a central opening 54 and a spring retainer groove 56. The spring retainer groove 56 is ring shaped and extends around the central opening 54. As shown in FIGS. 1-4, the assembly 51 has a flapper plate 58 having a spring contact surface 60, an opposed gasket support side 62, and spokes 64 that extend to a hub portion 66 having a hub opening 68. Retainer flow openings 69 are defined between the spokes 64, as shown in FIG. 4. An alternate embodiment of the flapper plate 58 is shown in FIG. 5. The flapper plate shown in FIG. 5 includes additional structure in the form of a concentric ring 61 extending between the spokes 64. As shown in FIG. 1, a gasket 70 is joined to the gasket support side 62 of the flapper plate 58 with an adhesive or other suitable means for joining.

A diaphragm member 76 having a protrusion 77 with a hub receiving groove 78, as shown in FIG. 1, is positioned in the hub opening 68 such that the diaphragm member 76 and flapper plate 58 are joined. As shown in FIGS. 1-3, a flapper 80 extends from the diaphragm member 76, the flapper 80 is flexible and is movable between an open position 82, as shown in FIG. 3, and a closed position 84 as shown in FIGS. 1 and 2. The flapper 80 is made of silicone, but may be any suitable flexible material. It is pointed out that when the flapper 80 is in the closed position 84 it is seated against the gasket 70 and closes the retainer flow openings 69. Thus, the flapper 80 seats against the gasket 70 when the bi-directional valve 20 is non-operational or in steady state shown in FIG. 1.

The assembly 51 includes a spring 86 with opposed ends. One end of the spring 86 is positioned in the spring retainer groove 56 in the first spring retainer 52, and the other end of the spring 86 abuts against the flapper plate 58. As shown in FIG. 1, the spring 86 holds the flapper plate 58 and gasket 70 against the gasket contact surface 46 of the first housing half portion 40 when the bi-directional valve 20 is non-operational or steady state shown in FIG. 1.

The bi-directional valve 20 advantageously allows for flow in two directions through the same general flow path 90. The flow path 90 in the direction of arrow B, shown in FIG. 2, extends through the first opening 30 in the first side 28 of the housing 22, the first housing portion 40, the central opening 54 in the spring retainer 52, the second housing portion 42 and through the second opening 34 in the second side 32 of the housing 22.

In use, the bi-directional valve 20 opens and closes as shown in FIGS. 1-3. In particular, the process begins with the bi-directional valve 20 in a steady state as shown in FIG. 1. Next, a high pressure acts on the assembly 51 causing it to move in the direction of arrow A in FIG. 2 and to open the flow path. It is pointed out that the flapper 80 is in the closed position 84. High pressure gas forces the gasket 70 to unseat from the gasket contact surface 46 of the first housing portion 40, and the gas flows through the flow path 90 in the direction indicated by the arrows designated B. The gas flowing through the flow path 90 is discharged to a region of lower pressure, and when the pressure falls below a predetermined pressure the assembly 51 returns to its steady state as shown in FIG. 1.

Turning to FIG. 3, the bi-directional valve 20 also provides for flow in the opposite direction as indicated by the arrow labeled C. Gasket 70 is held against the gasket contact surface 46 by the spring 86 to seal the opening 30 (FIG. 2) in the closed position. A pressure differential causes the flapper 80 to open to allow flow in the direction of arrow D along path 90.

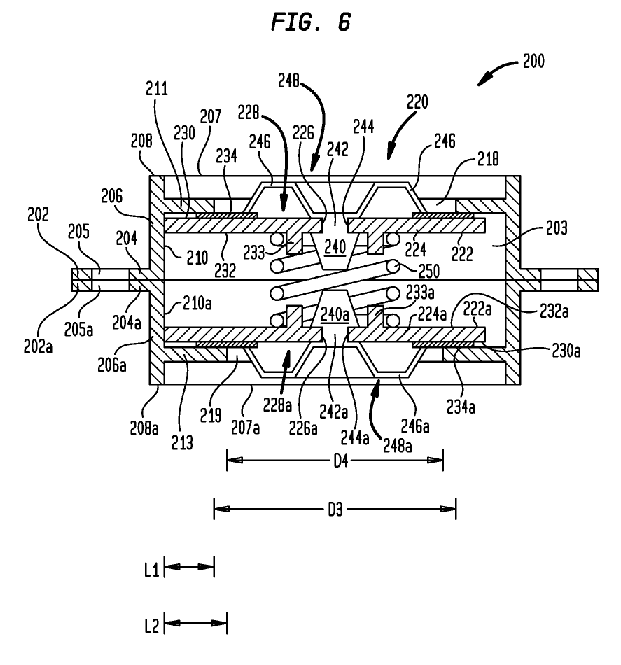

FIGS. 6-8 show a second embodiment of a bi-directional valve 200. FIG. 6 is a sectional view of the bi-directional valve 200 in a steady state or non-operational state. The bi-directional valve 200 has a first housing half 204 with a connecting portion 202, and a second housing half 204a with a connection portion 202a. The connection portions 202, 202a, respectively, have fastener openings 205, 205a, respectively, and bolts, screws, or other fastening means (not shown) hold the first and second housing halves 204, 204a, respectively, together. The first and second housing halves 204, 204a, respectively, define therein a housing interior 203. The bi-directional valve 200 also has a first side 207 and an opposed second side 207a.

As shown in FIG. 6, extension portions 206, 206a, respectively, extend at substantially a right angle to the connection portions 202, 202a, respectively, and extend to opposed housing end walls 208, 208a, respectively. The first and second housing halves 204, 204a, respectively, have inner surfaces 210, 210a, respectively, and a first inner wall 211 extends from the inner surface 210 of the first housing half 204, and a second inner wall 213 extends from the inner surface 210a of the second housing half 204a. The first inner wall 211 has a length designated L1 that is less that the length of the second inner wall 213 designated L2. The first inner wall 211 defines a first inner wall opening 218 having a diameter designated D3, and the second inner wall 213 defines a second inner wall opening 219 having a diameter designated D4 that is less than the diameter D3.

The bi-directional valve 200 has a valve assembly 220 positioned in the interior 203 thereof. The valve assembly 220 includes first and second flapper plates 222, 222a, respectively. The first plate 222 has first spokes 224 that extend to a first hub 226, and first flow openings 228 extend between the first spokes 224. The first plate 222 also has a first gasket side 230 and an opposed first spring side 232 from which extends a first spring retainer 233. A first gasket 234 is joined to the first gasket side 230 with an adhesive or by other suitable means. The second plate 222a has second spokes 224a that extend to a second hub 226a, and second flow openings 228a extend between the second spokes 224a. The second flapper plate 222a also has a second gasket side 230a and an opposed second spring side 232a from which extends a second spring retainer 233a. A second gasket 234a is joined to the second gasket side 230a with an adhesive or by other suitable means.

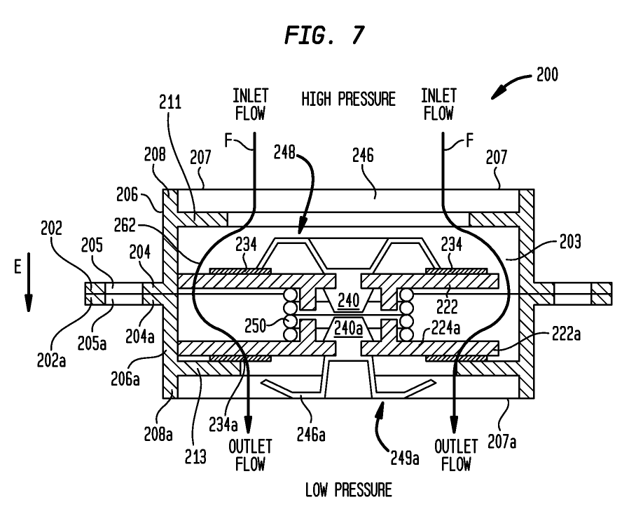

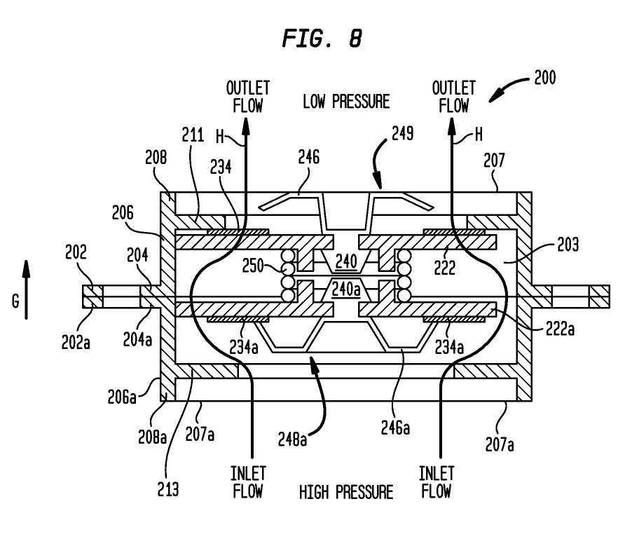

First and second diaphragm members 240, 240a, respectively, are joined to the first and second flapper plate 222, 222a, respectively. The first diaphragm member 240 has a first body 242 having a first annular groove 244, and the first hub 226 is positioned in the first annular groove 244 and is thereby joined to the first hub 226. Extending from the first diaphragm member 240 is a first flapper 246. The first flapper 246 is normally seated against the first gasket 234, and is capable of being lifting off the surface of the first gasket 234 when downstream pressure reaches a predetermined level. Thus, the first flapper 246 is capable of moving between a closed position 248 as shown in FIG. 6 and an open position 249 as shown in FIG. 8. Similarly, the second diaphragm member 240a has a second body 242a having a second annular groove 244a, and the second hub 226a is positioned in the second annular groove 244a and is thereby joined to the second hub 226a. Extending from the second diaphragm member 240a is a second flapper 246a. The second flapper 246a is normally seated against the second gasket 234a, and is capable of lifting off the surface of the second gasket 234a when downstream pressure reaches a predetermined level. Thus, the second flapper 246a is capable of moving between a closed position 248a as shown in FIG. 6 and an open position 249a as shown in FIG. 7.

A spring 250 is positioned between the first and second plates 222, 222a, respectively, and around the first and second spring retainers 233, 233a, respectively. The spring 250 holds the first and second gaskets 234, 234a, respectively, against the first and second inner walls 211, 213, respectively. The bi-directional valve 200 is shown in a non-operational or steady state in FIG. 6.

In use, as shown in FIG. 7, flow is through the high pressure side or first side 207 of the bi-directional valve 200 and continues to the second side 207a. As shown, the spring 250 compresses in the direction of arrow E. Flow moves along flow path 262, which is defined by the first and second housing halves 204, 204a, respectively, in the direction indicated by the arrows designated F. The pressure of the gas lifts the second flapper 246a from the second gasket 234a and the gas exits the bi-directional valve 200.

As shown in FIG. 8, flow is through the high pressure side or second side 207a of the bi-directional valve 200. The spring 250 compresses in the direction of arrow G. Flow moves along a flow path in the direction indicated by the arrows designated H. The pressure lifts the first flapper 246 from the first gasket 234 and the gas exits the bi-directional valve 200. The bi-directional valve 200 can be used in the same manner as described above in connection with the first embodiment to allow ambient air into a breathing mask to satisfy the user's breathing requirements, and allow exhaled gases to be exhausted through the same flow path indicated by arrows H.

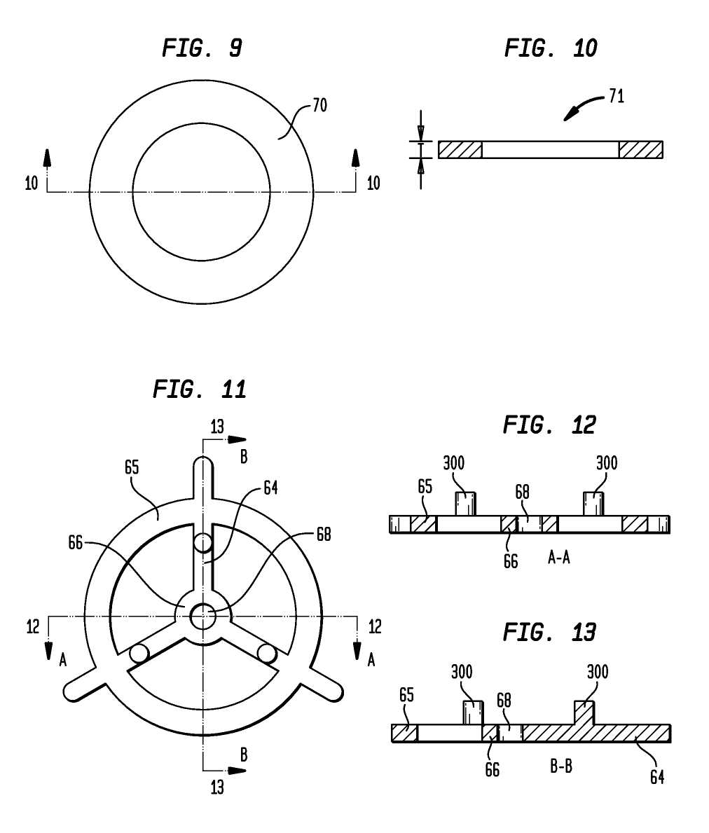

Turning to FIGS. 9-10, gasket 70 may be the ring type with a central opening 71 and a thickness T. As shown in FIG. 2, gasket 70 is mounted on the flapper plate 58.

FIGS. 11-13 show details of the flapper plate 58. The flapper plate 58 has a central hub opening 68. A hub portion 66 is connected by spokes 64 to an outer ring portion 65. The flapper plate 58 also includes upstanding spring retainers 300 disposed around the periphery of the flapper plate 58. The spring retainers 300 maintain the alignment of the spring 86.

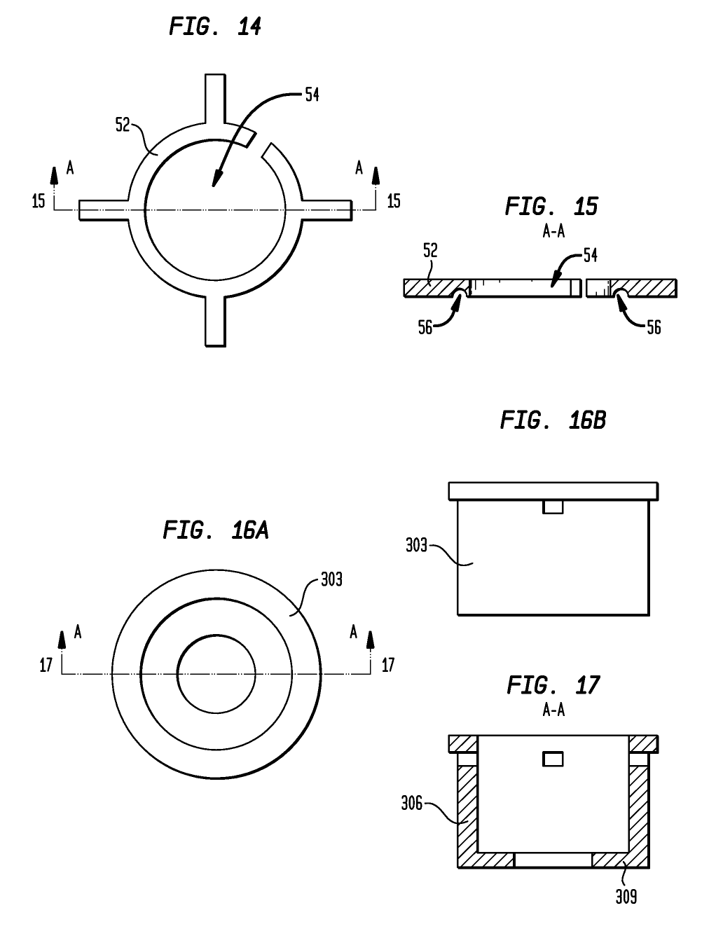

FIGS. 14-15 show the spring retainer 52 that is disposed opposite the flapper plate 58 in the assembly shown in FIG. 1. The spring retainer 52 has a central opening 54 and a spring retainer groove 56 that is ring shaped and extends around the central opening 54.

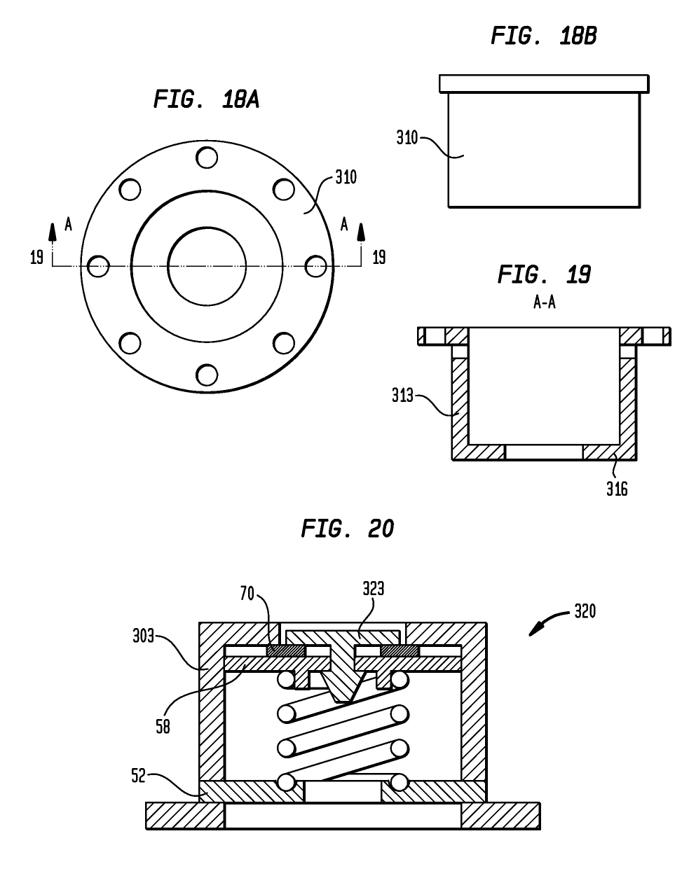

In FIGS. 16-17, a housing 303 may be used with the valve assembly 20 shown in FIGS. 1-3. The housing 303 has a side wall 306 and a bottom wall 309. In FIGS. 18-19, a housing 310 for use with the valve assembly 200 shown in FIGS. 6-8 is shown. The housing 310 has a side wall 313 and a bottom wall 316.

Turning to FIG. 20, an alternate embodiment of the valve 20 is shown. The valve assembly 320 has a flapper valve 323 that has a flat design. The bi-directional valve of FIG. 20 is shown in the non-operational or steady-state configuration.

In FIG. 21, a valve assembly 330 is shown. The valve assembly 330 has a flapper valve 333 with a high efficiency multiple convolution design.

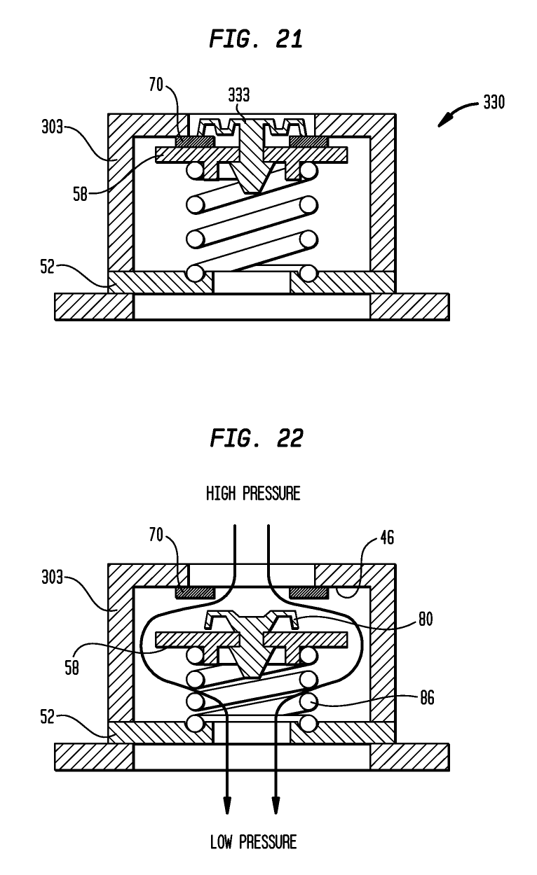

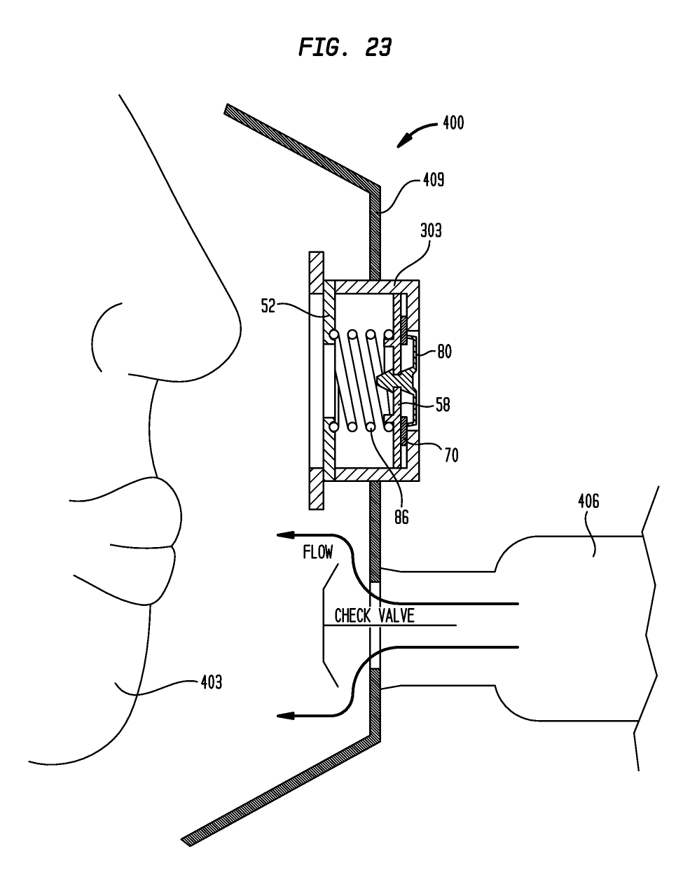

In FIG. 22, an alternate mounting configuration for the gasket 70 is shown. Instead of mounting the gasket 70 to a flapper plate 58, the gasket 70 is mounted directly to the housing 303 on surface 46.

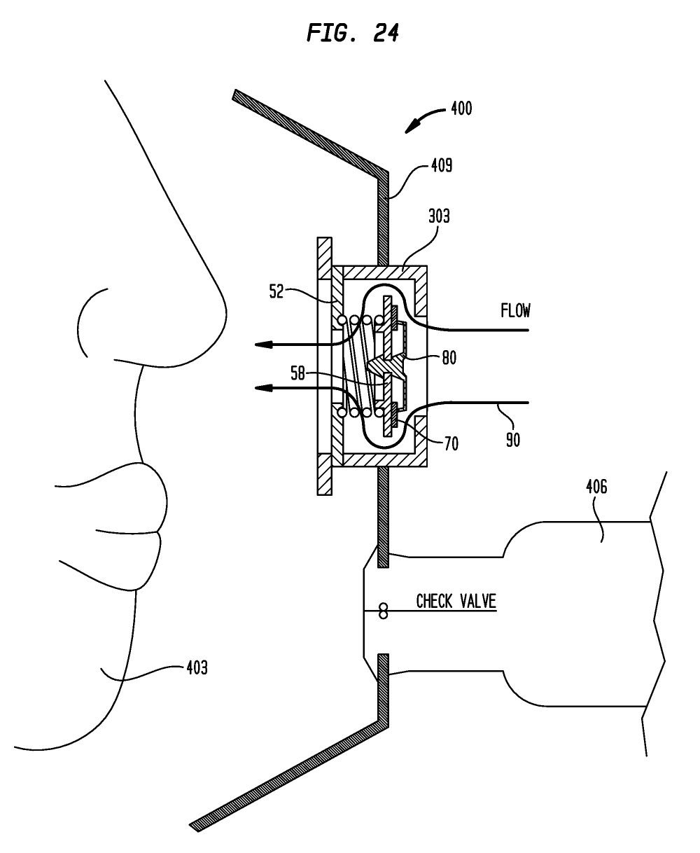

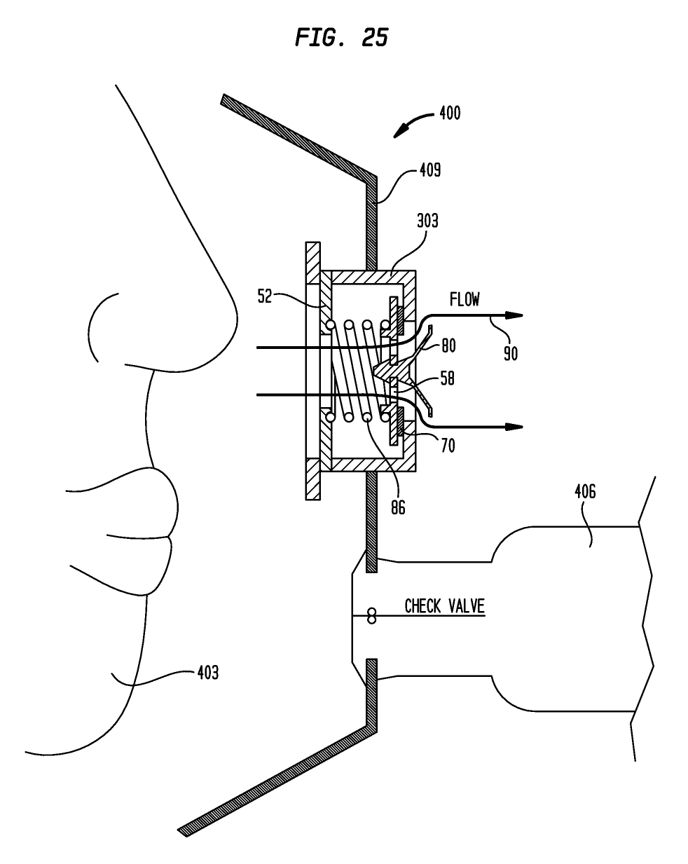

The bi-directional valves 20 are especially useful in a respiratory protective cover 400 such as an aviation oxygen mask as shown in FIGS. 23-25. The cover 400 may enclose the nose and mouth. The cover 400 may be embodied by a half face piece, a full mask, or a full respiratory hood. The user 403 inhales fresh oxygen, which can be supplied to the cover 400 from a supply hose (not shown) to the reservoir bag 406 (FIG. 23). Since the user's tidal volume can exceed what is delivered by the hose and reservoir bag 406 there is a need for additional gas volume. When this occurs, the flapper 80 and plate 58 will move away from the top of the valve 20 when the specified pressure is reached so ambient air can flow through the valve 20 into the face piece 409 of the cover 400 to satisfy the user's tidal volume requirement (FIG. 24). The flapper 80 and plate 58 will then return to their original position once the user 403 has stopped inhaling. When the user 403 exhales, the flapper 80 will then open and allow the exhaled gas to pass freely out the face piece 409 and into the ambient atmosphere. (FIG. 25).

Thus, the housing 22 has one flow path 90 that is advantageously configured to allow for the flow of gas in two opposite directions along the same flow path 90. Another advantage is the anti-suffocation function of the valve which provides that ambient air is always available to satisfy the user's tidal volume requirement.

The bi-directional valves described herein have many advantages over past valves. These advantages include a high flow efficiency for the size of the bi-directional valve. In addition, the bi-directional valve can be made with virtually any desired opening pressure, and thus variable opening pressures are can be obtained. And, very low opening pressures can be achieved, and the same flow path is used in the bi-directional valve for flow in either direction.

Another advantage is that by varying the spring rate characteristics and the exposed area on both sides of the valve assembly, opening pressures can be adjusted so each side of the valve assembly can have a separate opening pressure, or the same opening pressure. If the one side of the valve assembly is acting as a check valve, flow can simply exit the flapper while the plate and gasket will seal against the valve housing.

The bi-directional valves described herein have many advantages over past valves. These valves are useful in any case where fluids are to be transferred and space is constrained. The valves are particularly useful in application such as an aviation oxygen mask. The bi-directional valve may be used to perform the function of two separate valves and is in a package that is only slightly larger than that of one valve when two are required. The reason for this space savings is that gas can flow in one direction while the other direction is sealed. This feature is especially useful in an aviation mask where the prevailing direction of flow reverses when a person inhales or exhales. The valve is efficient because the valve plate is shaped to allow fluid flow both through and around the plate. The opening pressure on either side of the valve can be set very low if the spring and the differential area openings are set correctly. The flapper on one or both sides of the valves allows flow to exit the valve while the other side of the valve is sealed. These flappers can also be designed such that flow is maximized for a certain pressure drop.

It will be appreciated by those skilled in the art that while the bi-directional valve invention has been described above in connection with particular embodiments and examples, the invention is not necessarily so limited, and other embodiments, examples, uses, and modifications and departures from the described embodiments, examples, and uses may be made without departing from the bi-directional valve of this invention. All of these embodiments are intended to be within the scope and spirit of the present bi-directional valve.

What is claimed:

1. A bi-directional valve, comprising:
a housing having an internal gasket contact surface;
a plate disposed inside the housing;
a gasket disposed between the plate and the gasket contact surface;
a diaphragm member having a flapper, the diaphragm member being supported by the plate;
a biasing member for holding the gasket against the internal gasket contact surface such that when a pressure acts on the plate and the diaphragm, the flapper remains closed and the gasket moves away from the gasket contact surface to allow flow in a first direction, and when a pressure from the opposite direction acts on the plate, the flapper opens to allow flow in a second direction and the gasket remains in contact with the internal gasket contact surface.

2. The bi-directional valve of claim 1, wherein the plate has a hub disposed in the center, the hub having an opening defined therein.

3. The bi-directional valve of claim 2, wherein the flapper is attached to the opening in the hub.

4. The bi-directional valve of claim 2, wherein the plate has a plurality of spokes extending radially about the opening in the hub.

5. The bi-directional valve of claim 1, wherein the plate is formed with at least two concentric rings.

6. The bi-directional valve of claim 1, wherein the plate has a projection for engaging with the biasing member.

7. The bi-directional valve of claim 1, wherein the biasing member is a spring.

8. The bi-directional valve of claim 1, further comprising a retainer having a groove for engaging with the biasing member to hold it in position.

9. The bi-directional valve of claim 1, wherein the flapper seals against the gasket in a closed position.

10. The bi-directional valve of claim 1, wherein the gasket is attached to the plate.

11. A breathing apparatus, comprising:
a respiratory protective cover having a first opening and a second opening;
a one-way inhalation valve disposed in the first opening;
a bi-directional valve disposed in the second opening, the bi-directional valve having a housing having an internal gasket contact surface, a plate disposed inside the housing, a gasket disposed between the plate and the gasket contact surface, a diaphragm member having a flapper, the diaphragm member being supported by the plate, a biasing member for holding the gasket against the internal gasket contact surface such that when a pressure acts on the plate and the diaphragm, the flapper remains closed and the gasket moves away from the gasket contact surface to allow flow in a first direction, and when a pressure from the opposite direction acts on the plate, the flapper opens to allow flow in a second direction and the gasket remains in contact with the internal gasket contact surface; and,
a source of breathable gas disposed in fluid communication with the one-way inhalation valve.

12. The breathing apparatus of claim 11, wherein the bi-directional valve functions as an anti-suffocation valve during inhalation.

13. The breathing apparatus of claim 11, wherein the bi-directional valve functions as an exhalation valve.

14. A bi-directional valve, comprising:
a first housing portion having an internal gasket contact portion, a plate disposed in the first housing portion, a gasket disposed between the plate and the internal gasket contact portion, and a diaphragm member having a flapper, the diaphragm member supported by the plate;
a second housing portion adjacent to the first housing portion, the second housing portion having an internal gasket contact portion, a plate disposed in the second housing portion, a gasket disposed between the plate and the internal gasket contact portion, and a diaphragm member having a flapper, the diaphragm member supported by the plate;
a biasing member having a first end and a second end, the first end acting on the plate in the first housing portion and the second end acting on the plate in the second housing portion; and,
wherein when a predetermined pressure is applied to one of the plates in the first and second housing, the biasing member is compressed to allow flow through the first and second housing portions and out one of the flappers.

15. The bi-directional valve of claim 14, wherein the plate has a hub disposed in the center, the hub having an opening defined therein.

16. The bi-directional valve of claim 15, wherein the flapper is attached to the opening in the hub.

17. The bi-directional valve of claim 15, wherein the plate has a plurality of spokes extending radially about the opening in the hub.

18. The bi-directional valve of claim 14, wherein the plate is formed with at least two concentric rings.

19. The bi-directional valve of claim 14, wherein the plate has a projection for engaging with the biasing member.

20. The bi-directional valve of claim 14, wherein the biasing member is a spring.

21. The bi-directional valve of claim 14, further comprising a retainer having a groove for engaging with the biasing member to hold it in position.

22. The bi-directional valve of claim 14, wherein the flapper seals against the gasket in a closed position.

23. The bi-directional valve of claim 14, wherein the gasket is attached to the plate.

24. A breathing apparatus, comprising:
a respiratory protective cover having a first opening and a second opening;
a one-way inhalation valve disposed in the first opening;
a bi-directional valve disposed in the second opening, the bi-directional valve having a first housing portion having an internal gasket contact portion, a plate disposed in the first housing portion, a gasket disposed between the plate and the internal gasket contact portion, and a diaphragm member having a flapper, the diaphragm member supported by the plate, a second housing portion adjacent to the first housing portion, the second housing portion having an internal gasket contact portion, a plate disposed in the second housing portion, a gasket disposed between the plate and the internal gasket contact portion, and a diaphragm member having a flapper, the diaphragm member supported by the plate, a biasing member having a first end and a second end, the first end acting on the plate in the first housing portion and the second end acting on the plate in the second housing portion, and wherein when a predetermined pressure is applied to one of the plates in the first and second housing, the biasing member is compressed to allow flow through the first and second housing portions and out one of the flappers; and,
a source of breathable gas disposed in fluid communication with the one-way inhalation valve.
